(19) United States
(12) Patent Application Publication
(10) Pub. No.: US 2025/0348777 A1
(43) Pub. Date: Nov. 13, 2025

(54) System and method to reduce latency in machine learning models

(71) Applicant: Bank of America Corporation, Charlotte, NC (US)

(72) Inventors: Claude N Kouakou, Concord, NC (US); Sivashalini Sivajothi, Chennai (IN); Maneesh Kumar Sethia, Hyderabad (IN); Shameera Roohin Mohammed Nasrullah, Chengalpattu (IN); Parameswari K, Chennai (IN)

(21) Appl. No.: 18/657,536

(22) Filed: May 7, 2024

(51) Int. Cl. G06N 20/00

(52) U.S. Cl. CPC G06N 20/00

(57) ABSTRACT

An apparatus comprises a memory communicatively coupled to a processor. The processor is configured to receive information parameters associated with a machine learning (ML) model of the one or more ML models and execute an ML algorithm to evaluate the information parameters in accordance with one or more latency classification operations. The one or more latency classification operations are configured to determine whether the ML model comprises multiple latency complications. Further, the processor is configured to generate multiple analysis results indicating that the ML model comprises the latency complications in response to evaluating the information parameters, determine a latency cause of the latency complications based on the analysis results, and determine multiple corrective operations configured to correct the latency cause. The processor is configured to update the ML model to comprise the corrective operations and generate a report configured to release an updated version of the ML model.

### TECHNICAL FIELD

The present disclosure relates generally to operations associated with reducing latency in machine learning models, and more specifically to a system and method to reduce latency in machine learning models.

### BACKGROUND

In certain communication systems, a communication device may experience delays and/or latency issues after being updated from an original configuration to an updated configuration in an update procedure. In particular, the communication device may experience performance delays after executing update procedures that modify or replace the original configuration. If performance delays are identified after executing an update procedure in a communication device, the communication device may be considered to be unreliable during one or more operations.

### SUMMARY OF THE DISCLOSURE

In one or more embodiments, systems and methods described herein are configured to reduce latency in machine learning (ML) models. In particular, the systems may be configured to execute an ML algorithm to correct performance delays and/or latency issues in local ML models. The systems are configured to reduce, prevent, and/or eliminate performance delays and/or latency issues in local ML models after the local ML models are updated from previous configurations to new configurations in one or more update procedures. The local ML models may be configuration frameworks deployed and presented in real-time usage upon execution of a local ML algorithm in user devices and/or network devices communicatively coupled to the systems. The systems may be configured to perform one or more latency classification operations to determine latency causes for local ML models undergoing performance delays and/or latency issues. In this regard, the systems may be configured to perform one or more corrective operations to prevent performance delays and/or latency issues to continue in the local ML models. The latency causes may be results of recent updates to information parameters in the local ML models. The information parameters may comprise triggers, outputs, and data sets used to train and/or maintain the local ML models. The corrective operations may comprise selective changes to specific elements in the information parameters. For example, the systems may determine that execution of an ML algorithm in accordance with a specific local ML model is causing latency issues because of unexpected changes to a local database and/or data set. In this example, the latency issues may be caused because the local ML model is not updated to account for one or more changes (e.g., data sizes, data types, and the like) in the local database. Herein, the corrective operations suggested and/or implemented by the systems may comprise additional updates to the local ML model to account for the one or more changes to the local database.

In some embodiments, the systems may comprise a latency identification framework configured to identify and correct latency issues in any type of local ML model while the local ML model is performing one or more data exchange operations. For a specific local ML model, the systems may be configured to analyze several components of the specific local ML model as the ML performs the data exchange operations to identify issues in the specific local ML model. In response to identifying issues in the specific local ML model, the systems are configured to identify corresponding latency causes. After the systems identify corresponding latency causes, the systems may be configured to perform one or more pinpoint corrective operations to reduce and/or eliminate the latency causes without affecting additional information parameters of the specific local ML model.

In one or more embodiments, the systems and methods described herein are integrated into a practical application of reducing performance delays and/or latency issues in local ML models. The systems may be configured to execute an ML algorithm to determine whether the performance delays and/or latency issues are caused by changes brought by update procedures to any triggers, outputs, and/or data sets associated with a given local ML model. In this regard, the ML algorithm may be executed to determine and correct performance delays and/or latency issues in existing local ML models by evaluating information parameters of the local ML models, deriving possible latency causes based on the information parameters, determining one or more corrective operations corresponding to the possible latency causes, and updating the local ML models to include corrected information parameters. The systems may update the local ML models in real-time and/or without requiring reversal of previous update procedures to reduce and/or prevent downtime.

In one or more embodiments, the systems and methods are directed to improvements in computer systems. Specifically, the systems reduce processor and memory usage in user devices and/or network devices performing operations in accordance with local ML models undergoing performance delays and/or latency issues. In particular, the systems reduce processor and memory usage in these devices because the systems identify latency causes in the local ML models and dynamically provide corrective operations to reduce and/or eliminate the latency causes. Further, the systems reduce resource usage in computer systems configured to reduce and/or prevent performance delays and/or latency issues in these devices by preventing, reducing, and/or eliminating security operations that may be required to revert local ML models to previous versions, retroactively lock data sets associated with the local ML models, and/or protect information in the devices. Instead, the systems are configured to diagnose and correct latency causes for local ML models without revering the local ML models to a previous configuration.

In one or more embodiments, the systems and the methods may be performed by an apparatus, such as the server. Further, the system may be a data exchange system, which comprises the apparatus. In addition, the system and the method may be performed as part of a process performed by the apparatus. As a non-limiting example, the apparatus may comprise a memory and a processor communicatively coupled to one another. The memory may be operable to store a machine learning algorithm configured to evaluate latency in one or more machine learning models. The processor may be configured to receive information parameters associated with a machine learning model of the one or more machine learning models. The information parameters may be a basis to perform multiple data exchange operations. The information parameters may comprise multiple data sets, multiple triggers, and multiple outputs. Further, the processor may be configured to execute the machine learning algorithm to evaluate the information parameters in accordance with one or more latency classification operations, the one or more latency classification operations may be configured to determine whether the machine learning model comprises multiple latency complications, generate multiple analysis results indicating that the machine learning model comprises the latency complications in response to evaluating the information parameters, determine a latency cause of the latency complications based on the analysis results, and determine multiple corrective operations configured to correct the latency cause. The processor may be configured to update the machine learning model to comprise the corrective operations and generate a report configured to release an updated version of the machine learning model.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments; and

FIG. 2 illustrates an example flowchart of a method to reduce latency in machine learning models in accordance with one or more embodiments.

### DETAILED DESCRIPTION

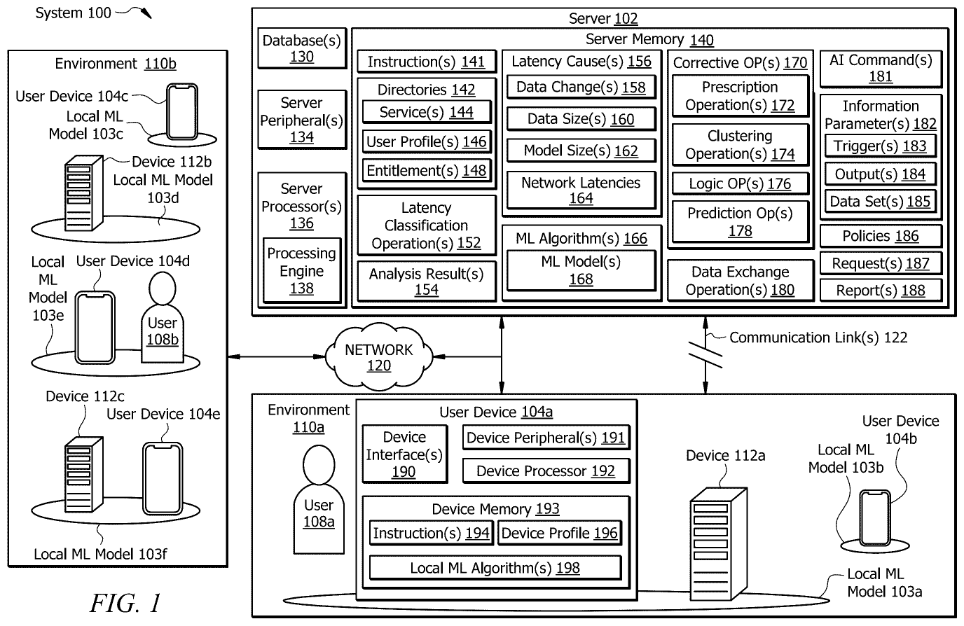

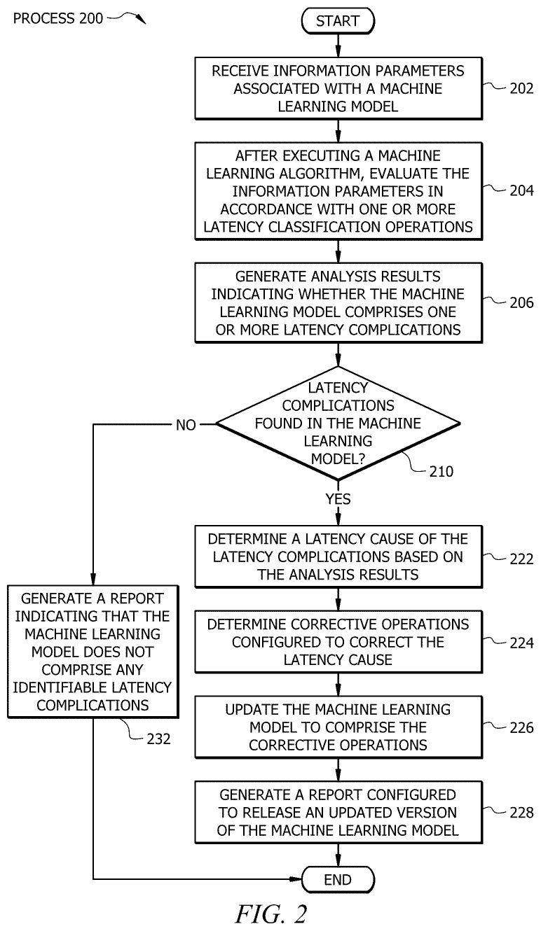

As described above, this disclosure provides various systems and methods to reduce latency in machine learning models. FIG. 1 illustrates a system 100 in which a server 102 is configured to reduce, prevent, and/or eliminate performance delays and/or latency issues in local machine learning models 103. FIG. 2 illustrates a process 200 performed by the system 100 of FIG. 1 to improve performance of local machine learning models 103.

### System Overview

FIG. 1 illustrates an example system 100, in accordance with one or more embodiments. The system 100 may be configured to dynamically monitor, control, and/or protect operations performed by a server 102 communicatively coupled to at least one user device 104a associated with a user 108a in a given environment 110a. In the environment 110a, the user device 104a may be communicatively coupled to at least one network device 112a configured to perform one or more operations in accordance with a machine learning (ML) model 103a. The system 100 comprises the environment 110a and an environment 110b (collectively, environments 110). The environment 110a comprises the user device 104a and the network device 112a communicatively coupled to one another and performing operations in accordance with the local ML model 103a. Further, the environment 110a comprises a network device 112b performing operations in accordance with a local ML model 103b. The local ML model 103a and the local ML model 103b (collectively, local ML models 103) are instructions and/or guidelines configured to be trained by extracting patterns from training data and evaluate input data by using patterns to predict one results. The environment 110b comprises a user device 104c performing operations in accordance with a local ML model 103c, a network device 112b performing operations in accordance with a local ML model 103d, a user device 104d associated with a user 108b and performing operations in accordance with a local ML model 103e, and a user device 104e and a network device 112c performing operations in accordance with a local ML model 103f. The user device 104a, the user device 104b, the user device 104c, and the user device 104d (collectively, user devices 104) may be devices associated with the server 102 and configured to monitor, control, and/or perform operations in the environments 110. The user devices 104 may be configured to perform one or more operations in communication with one or more of the network device 112a, the network device 112b, and the network device 112c (collectively, network devices 112). The network devices 112 may be configured to track, monitor, and/or evaluate interactions within corresponding ranges 114 in the environments 110. The devices in the environments 110 may be communicatively coupled to the server 102 via a network 120 and/or one or more direct communication links (one or more communication links 122).

In one or more embodiments, the admin server 102 may comprise one or more databases 130, one or more server peripherals 134, one or more server processors 136 comprising a processing engine 138, and at least one memory 140 communicatively coupled to one another. In some embodiments, the memory 140 may be operable to store one or more instructions 141, one or more directories 142 relating one or more services 144 with one or more user profiles 146 and one or more entitlements 148, one or more latency classification operations 150, one or more analysis results 154, one or more latency causes 156 comprising one or more data changes 158, one or more data sizes 160, one or more model sizes 162, and one or more network latencies 164, one or more server ML algorithms 166 comprising one or more server ML models 168, one or more corrective operations 170 comprising one or more prescription operations 172, one or more clustering operations 174, one or more logic operations 176, and one or more prediction operations 178. Further, the server memory 140 may be operable to store one or more data exchange operations 180, one or more artificial intelligence (AI) commands 181, one or more information parameters 182 comprising one or more triggers 183, one or more outputs 184, and one or more data sets 185, one or more policies 186, one or more requests 187, and one or more reports 188.

Referring to the user device 104a a non-limiting example, the user device 104a may comprise at least one device interface 190, one or more device peripherals 191, at least one device processor 192, and at least one device memory 193 comprising device instructions 194, at least one device profile 196, and one or more local ML algorithms 198.

### Security System Components

### Server

In one or more embodiments, the server 102 is generally any device or apparatus that is configured to process data and communicate with computing devices (e.g., user devices 104), the databases 130, systems, and the like, via one or more interfaces (i.e., user interface or network interface in the server peripherals 134). The server 102 may comprise a server processor 136 that is generally configured to oversee operations of a processing engine 138. The server 102 comprises the server processor 136 communicatively coupled with the server peripherals 134, and a server memory 140. The server 102 may be configured as shown, or in any other configuration.

In one or more embodiments, the databases 130 may be one or more repositories configured to store information. In one example, the server 102 may determine the server processors 136 are available (e.g., running) to perform a specific service. In another example, the server 102 may determine that a specific managed server (not shown) is running to enable a testing application and/or perform the specific service upon receiving a server response indicating that a corresponding managed server is available to perform the service. The databases 130 may be configured to store one or more representations of data instead of storing coded data. In this regard, the representations may be encoded in accordance with an encoder configured to identify and/or verify exchanged information. For example, the databases 130 may comprise one or more representations of multiple datapoints. As the datapoints are obtained, the server processors 136 may be configured to compare the datapoints with a representation of a previous version for a specific user 108.

In one or more embodiments, the server peripherals 134 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server peripherals 134 may be configured to support any suitable type of communication protocol as would be appreciated by one of ordinary skill in the art.

In one or more embodiments, the server peripherals 134 may be configured to enable wired and/or wireless communications. The server peripherals 134 may be configured to communicate data between the server 102 and other user devices 104, network devices, systems, or domain(s) via the network 120. For example, the server peripherals 134 may comprise a network interface that comprises a WIFI interface, a LAN interface, a WAN interface, a modem, a switch, or a router. The server processor 136 may be configured to send and receive data using the server peripherals 134. The server peripherals 134 may be configured to use any suitable type of communication protocol.

The server processor 136 comprises one or more processors communicatively coupled to the server memory 140. The server processor 136 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 136 may be a programmable logic device, a microcontroller, a microprocessor, or any suitable combination of the preceding. The one or more server processors 136 are configured to process data and may be implemented in hardware or software executed by hardware. For example, the server processor 136 may be 8-bit, 16-bit, 32-bit, 64-bit or of any other suitable architecture. The server processor 136 may include an arithmetic logic unit (ALU) for performing arithmetic and logic operations, processor registers that supply operands to the ALU and store the results of ALU operations, and a control unit that fetches instructions 141 from the server memory 140 and executes them by directing the coordinated operations of the ALU, registers and other components. In this regard, the one or more server processors 136 are configured to execute various instructions 141. For example, the one or more server processors 136 are configured to execute the instructions 141 to implement the functions disclosed herein, such as some or all of those described with respect to FIGS. 1 and 2. In some embodiments, the functions described herein are implemented using logic units, FPGAs, ASICs, DSPs, or any other suitable hardware or electronic circuitry.

In some embodiments, the server processor 136 may be any combination of a processing accelerator, signal processing circuitry (e.g., including filters, mixers, oscillators, amplifiers, and the like), or digital processing circuitry (e.g., for digital modulation as well as other digital processing). The server processor 136 may be configured to create, analyze, manage, and update the one or more directories 142, one or more latency classification operations 152, one or more latency causes 156, one or more corrective operations 170, one or more data exchange operations 180, one or more information parameters 182, and/or the one or more policies 186. The server processor 136 may be configured to communicate with the one or more network devices 112 via the server peripherals 134 and the network 120. The server processor 136 may be configured to perform one or more of the operations 202-228 described below in reference to FIG. 2. In some embodiments, the server processor 136 may be configured to execute one or more of the latency classification operations 152, the one or more corrective operations 170, and/or the one or more data exchange operations 180.

The server memory 140 may be volatile or non-volatile and may comprise a read-only memory (ROM), random-access memory (RAM), ternary content-addressable memory (TCAM), dynamic random-access memory (DRAM), and static random-access memory (SRAM). The server memory 140 may be implemented using one or more disks, tape drives, solid-state drives, and/or the like. The server memory 140 is operable to store the one or more instructions 141, the one or more directories 142 relating the one or more services 144 with the one or more user profiles 146 and the one or more entitlements 148, the one or more latency classification operations 152, the one or more analysis results 154, the one or more latency causes 156 comprising the one or more data changes 158, the one or more data sizes 160, the one or more model sizes 162, and the one or more network latencies 164, the one or more server ML algorithms 166 comprising the one or more server ML models 168, the one or more corrective operations 170 comprising the one or more prescription operations 172, the one or more clustering operations 174, the one or more logic operations 176, and the one or more prediction operations 178. Further, the server memory 140 may be operable to store the one or more data exchange operations 180, one or more AI commands 181, one or more information parameters 182 comprising one or more triggers 183, one or more outputs 184, and one or more data sets 185, one or more policies 186, one or more requests 187, and one or more reports 188. The instructions 141 may comprise any suitable set of instructions, logic, rules, or code operable to execute the server processor 136.

The directories 142 may comprise the one or more services 144, the one or more user profiles 146, and the one or more entitlements 148. In one or more embodiments, the directories 142 may comprise identifiers that provide a reference number to each of the user profiles 146 associated with the server 102. The directories 142 may indicate one or more entitlements 148 corresponding to one or more services 144 associated with a given user profile 146. The user profiles 146 may comprise multiple profiles for users (e.g., user 108). Each user profiles 146 may comprise one or more entitlements 148. As described above, the entitlements 148 may indicate that a given user is allowed to access one or more network resources associated with the services 144 in accordance with one or more policies 186. The entitlements 148 may indicate that a given user is allowed to perform one or more operations in the network 120 (e.g., access a specific website on the Internet).

The latency classification operations 152 may be one or more operations configured performed to classify delays and/or latency issues in one or more local ML models 103. The local ML models 103 may be configuration frameworks deployed and presented in real-time usage upon execution of a local ML algorithm 198 in user devices 104 and/or network devices 112 communicatively coupled to the server 102. In some embodiments, the latency classification operations 152 may be configured to determine whether delays and/or latency issues are found in a specific local ML model 103, determine one or more latency causes 156 causing the delays and/or latency issues, and derive one or more corresponding corrective operations 170 configured to correct corresponding latency causes 156. The latency classification operations 152 may be performed upon executing one or more server ML algorithms 166 in accordance with one or more server ML models 168. The server ML algorithms 166 may be executed to perform the one or more latency classification operations 152. The latency classification operations 152 may comprise receiving a local ML model that may be undergoing one or more delays and/or latency issues (e.g., performance issues).

In one or more embodiments, the latency classification operations 152 are configured to evaluate multiple aspects of each local ML models 103. These aspects may be one or more information parameters 182 comprising one or more triggers 183, one or more outputs 184, and/or one or more data sets 185 of each local ML models 103. The information parameters 182 may be more or less than those shown in FIG. 1. The triggers 183 may be one or more commands configured to start, trigger, and/or initiate operations upon executing a local ML algorithm 198 in accordance with a corresponding local ML model 103. The outputs 184 may be one or more expected outputs upon execution, operation, and/or implementation of the execution of the local ML algorithms 198. The data sets 185 may be one or more sets of data accessible to one or more of the local ML algorithms 198. The data sets 185 may be data used to train the local ML algorithms 198 and/or one or more sets of data configured to provide the local ML algorithms 198 with reference information, input commands, additional triggers 183, and/or additional outputs 184.

In some embodiments, the latency classification operations 152 may be configured to classify delays and/or latency issues of the local ML models 103 into one or more categories. The analysis results 154 may be one or more results from analyses performed by the server ML algorithms 166. The latency classification operations 152 may be configured to generate one or more analysis results 154 indicating whether the information parameters 182 enable a local ML model 103 to meet an operational target. The operational target may be an expected performance associated with a specific local ML model. For example, a local ML model 103 may be configured to receive a trigger 183 to add a first value and a second value (e.g., from a data set 185) into a third value (e.g., an output 184). In this example, the operational target may be that a local ML algorithm 198 may be executed in accordance with a local ML model 103 to generate the third value upon adding the first value and the second value. If the analysis results 154 indicate (e.g., suggest and/or reference) that the information parameters 182 do not enable the local ML model 103 to meet a corresponding operational target, the latency classification operations 152 may be configured to indicate one or more latency causes 156 associated with any delays and/or latency issues in the local ML model 103.

The latency causes 156 may be one or more causes of performance delays and/or latency issues produced upon executing a specific local ML algorithm 198 in accordance with a specific local ML model 103. In some embodiments, “latency” is a measurement in ML systems to determine a performance of one or more models for a specific application. In this regard, “latency” may refer to a time that takes to load a specific local ML model 103 into a device memory 193, gather requisite data, and execute one or more operations. Herein, the latency causes 156 may be categorized in multiple categories. These categories may comprise issues caused by data changes 158, data sizes 160, model sizes 162, and/or network latencies 164 among others. The data changes 158 may be latency causes 156 that may occur in cases where new data is introduced for operations to a local ML algorithm 198 without training the local ML algorithm 198 with the new data. The data changes 158 may be one of the latency causes 156 in a specific local ML algorithm 198 after one or more update procedures change data over a period of time without training the local ML algorithm 198. The data sizes 160 may be latency causes 156 that may occur in cases where large data is introduced for operations to a local ML algorithm 198 without scaling the local ML algorithm 198 to match the large data. The data sizes 160 may be one of the latency causes 156 in a specific local ML algorithm 198 after one or more update procedures increase data over a period of time without scaling the local ML algorithm 198 to match large data sizes. The model sizes 162 may be latency causes 156 that may occur in cases where high loads and/or new model changes are introduced to a local ML algorithm 198 without matching configurations on the local ML algorithm 198. The model sizes 162 may be one of the latency causes 156 in a specific local ML algorithm 198 after one or more update procedures increase load and/or operations performed by the model without configuring the local ML algorithm 198 to meet the high load and/or the additional operations. The network latencies 164 may be latency causes 156 that may occur in cases where a local ML algorithm 198 interacts with portions of the network 120 causing round trip delays. The network latencies 164 may be one of the latency causes 156 in a specific local ML algorithm 198 after one or more update procedures change roundtrip time of communication operations to increase.

In one or more embodiments, the server ML algorithms 166 may be executed by the server processor 126 to evaluate the requests 187. Further, the server ML algorithms 166 may be configured to interpret and transform the requests 187 and/or the instructions 141 into structured data sets and subsequently stored as files or tables. The server ML algorithms 166 may cleanse, normalize raw data, and derive intermediate data to generate uniform data in terms of encoding, format, and data types. The server ML algorithms 166 may be executed to run user queries and advanced analytical tools on the structured data and/or the unstructured data in accordance with one or more server ML models 168. The server ML algorithms 166 may be configured to generate the one or more AI commands 181 based on one or more analysis results 154. The AI commands 181 may be parameters that proactively trigger one or more of the latency classification operations 152 to evaluate and/or classify the information parameters 182 of a specific local ML model 103 and/or one or more of the data exchange operations 180 to exchange data between one or more user devices 104, the network devices 112, and/or the server 102. The AI commands 181 may be combined with the existing instructions 141 to dynamically trigger and/or perform the latency classification operations 152 and/or the data exchange operations 180. The AI commands 181 may be configured to trigger one or more cognitive AI operations in accordance with one or more server ML models 168. The server ML models 168 may be trained by the one or more server ML algorithms 166 based on historic information associated with any latency classification operations 152 and/or data exchange operations 180 performed with the server 102.

In one or more embodiments, the one or more corrective operations 170 may be one or more correction operations to prevent, reduce, and/or eliminate delays and/or latency issues currently produced upon executing a specific local ML algorithm 198 in accordance with a specific local ML model 103. As described above, the server may be configured to perform the latency classification operations 152 to identify delays and/or latency issues in any type of local ML model 103 and help in automatic recovery. The server 102 may be configured to analyze the information parameters 182 in a specific local ML model 103, identify types of issues that the specific local ML model 103 is undergoing, and handle the specific local ML model 103 uniquely to solve the underlying issues and/or issue types. Herein, the server 102 may be configured to perform the latency classification operations 152 to classify the delays and/or latency issues into the one or more latency causes 156 comprising data changes 158, data sizes 160, model sizes 162, and/or network latencies 164 among others. In response to determining one or more latency causes 156 for delays and/or latency issues in the specific local ML model 103, the server 102 is configured to generate the one or more corrective operations 170.

In some embodiments, the server 102 may be configured to suggest one or more prescription operations 172 to prevent, reduce, and/or eliminate delays and/or latency issues caused by data changes 158 in a given local ML model 103. The one or more prescription operations 172 may be configured to correct inefficient and/or missed new data training in a given local ML model 103. The one or more prescription operations 172 may be performed as part of a prescriptive technique that is adapted to selectively identify missing areas or data in which the given local ML model 103 lacks training. Herein, the given local ML model is dynamically trained to incorporate some or all of the missed and/or new data.

In some embodiments, the server 102 may be configured to suggest one or more clustering operations 174 to prevent, reduce, and/or eliminate delays and/or latency issues caused by data sizes 160 in a given local ML model 103. The one or more clustering operations 174 may be configured to train the given local ML model 103 additional different data sets 185 and batches. Herein, based on the batch, the given local ML model 103 may be configured to map large structures into smaller sets, batch local requests for each of the smaller sets, and complete the requests more efficiently. In this regard, the local ML model 103 may be configured to generate one or more definite outputs by grouping and batching specific data types into smaller sets.

In some embodiments, the server 102 may be configured to suggest one or more logic operations 176 to prevent, reduce, and/or eliminate delays and/or latency issues caused by model sizes 162 in a given local ML model 103. The one or more logic operations 176 may be configured to execute clustering algorithms to refine large dataset by grouping similar data, scale up each cluster, and modify existing information parameters 182 to match one or more predefined target configurations. These target configurations may be configurations of the given local ML model determined to enable efficient operations of one or more local ML algorithms 198. The logic operations 176 may be configured to group similar sets of data into a single data set. Further, the logic operations 176 may be configured to reduce high loads in a heavily loaded model and/or reduce a size of the local ML model 103.

In some embodiments, the server 102 may be configured to suggest one or more prediction operations 178 to prevent, reduce, and/or eliminate delays and/or latency issues caused by network latencies 164 in a given local ML model 103. The one or more prediction operations 178 may be configured to train the given ML model 103 to identify a roundtrip time of a network and identify routing commands to reduce roundtrip times. The prediction operations may be configured to dynamically predict roundtrip times and reduce delays and/or latency issues based on the lowest times.

In one or more embodiments, the data exchange operations 180 may be executed by the server processor 136 configured to enable data objects to be exchanged between the server 102, the user devices 104, and/or the network devices 112 based on the one or more policies 186. In one or more embodiments, the data exchange operations 180 may be configured to indicate one or more data objects (e.g., via data object information) to be exchanged between the server 102 and at least one of the user devices 104 and/or the network devices 106. The data exchange operations 180 may be configured to generate and analyze one or more reports 188. The reports 188 may comprise data indicating warnings and alerts among other information. In some embodiments, the reports 188 may be audio and/or visual signaling presented in the one or more server peripherals 134 and/or the one or more device peripherals 191.

The one or more policies 186 may be security configuration commands or regulatory operations predefined by an organization or one or more users 108. In one or more embodiments, the one or more policies 186 may be dynamically defined by the one or more users 108. The one or more policies 186 may be prioritization rules configured to instruct one or more user devices 104 and/or the one or more network devices 106 to perform one or more operations or perform one or more operations in the system 100 in a specific request. The one or more one or more policies 186 may be predetermined or dynamically assigned by a corresponding user 108 or an organization associated with the user 108. The reports 188 comprise one or more communications and/or transmissions configured to provide information relating to a status of one or more of the latency classification operations 152 and/or one of the data exchange operations 180. The reports 188 may comprise and/or trigger alerts to other servers and/or one or more of the user devices 104.

The requests 187 may be one or more information strings, alphanumeric data, and/or configuration commands to be exchanged in a data network. The one or more requests 187 may be configured to trigger one or more of the latency classification operations 152 and/or one of the data exchange operations 180. The requests 187 may be exchanged in bulk or individually over the network 120. The requests 187 may be one or more communications configured to provide triggers in the form of communication or control signals to start operations such as fetching the instructions 141 or performing the latency classification operations 152 and/or one of the data exchange operations 180. The requests 187 may provide user information to the server 102 to indicate at least one user profile 146 associated with one or more of the entitlements 148 to access and/or modify any of the services 144 available in the server 102. In some embodiments, the requests 187 may be configured to provide lists, security information, and configuration commands that the server 102 uses to set up a specific service 144 for one of the user devices 104. The requests 187 may comprise data that provides starting procedure configuration to the server 102. In one or more embodiments, the requests 187 may be optimized instructions that trigger establishing of a specific procedure in the server 102.

In one or more embodiments, the server processor 136 may be configured to [interpret and transform the self-supervised information parameters 182 into structured data sets and subsequently stored as files or tables. The server processor 136 may cleanse, normalize raw data, and derive intermediate data to generate uniform data in terms of encoding, format, and data types. The server processor 136 may execute the instructions 141 to run user queries and advanced analytical tools on the structured data. The latency classification operations 152 and the data exchange operations 180 may be combined with existing server instructions 141 and/or existing configuration commands. In one or more embodiments, the latency classification operations 152 and the data exchange operations 180 may be periodically and/or dynamically updated.

### Network

The network 120 facilitates communication between and amongst the various devices of the system 100. The network 120 may be any suitable network operable to facilitate communication between the server 102, the user devices 104, and the network devices 112 of the system 100. The network 120 may include any interconnecting system capable of transmitting audio, video, signals, data, data packets (e.g., non-fungible tokens (NFT)), messages, or any combination of the preceding. The network 120 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

The communication link 122 is an example of a wired and/or wireless connection between the server 102 and at least one user device 104 and/or network device 112 in a given environment 110. The environments 110 may be virtual and/or physical spaces, channels, and/or areas in which the one or more user devices 104 and/or network devices 112 perform one or more communication operations.

### User Device

In one or more embodiments, each of the user devices 104 (e.g., the user devices 104a and 104b in the environment 110a) may be any computing device configured to communicate with other devices, such as the server 102, other network devices 112 in the environments 110, additional databases, and the like in the system 100. Each of the user devices 104 may be configured to perform specific functions described herein and interact with one or more user devices 104a-104e in the environments 110. Examples of user devices 104 comprise, but are not limited to, a laptop, a computer, a smartphone, a tablet, a smart device, an IoT device, a virtual reality device, an augmented reality device, or any other suitable type of device associated with one or more users 108.

The user devices 104 may be hardware configured to create, transmit, and/or receive information. The user devices 104 may be configured to receive inputs from a user, process the inputs, and generate data information or command information in response. The data information may include documents or files generated using a graphical user interface (GUI). The command information may include input selections/commands triggered by a user using a peripheral component or one or more device peripherals 191 (i.e., a keyboard) or an integrated input system (i.e., a touchscreen displaying the GUI). The user devices 104 may be communicatively coupled to the server 102 via a network connection (i.e., device interface 190 in the server 102). The user devices 104 may transmit and receive data information, command information, or a combination of both to and from the server 102 via the device interface 190. In one or more embodiments, the user devices 104 is configured to exchange data, commands, and signaling with the server 102. In some embodiments, the user devices 104 are configured to trigger the start of one or more communication operations. The user devices 104 may be configured to trigger the network devices 112 to perform one or more communication operations. In one or more embodiments, while FIG. 1 shows the user device 104a, the user device 104b, the user device 104c, the user device 104d, and the user device 104e, a given environment 110 may comprise less or more user devices 104.

In one or more embodiments, referring to the user device 104a as a non-limiting example of the user devices 104, the user device 104a may comprise one or more device interfaces 190, one or more device peripherals 191, a device processor 192, and a device memory 193. The device interfaces 190 may be any suitable hardware or software (e.g., executed by hardware) to facilitate any suitable type of communication in wireless or wired connections. These connections may comprise, but not be limited to, all or a portion of network connections coupled to an additional user device 104b, the server 102, the Internet, an Intranet, a private network, a public network, a peer-to-peer network, the public switched telephone network, a cellular network, a LAN, a MAN, a WAN, and a satellite network. The device interfaces 190 may be configured to support any suitable type of communication protocol.

In one or more embodiments, the one or more device peripherals 191 may comprise audio devices (e.g., speaker, microphones, and the like), input devices (e.g., keyboard, mouse, and the like), or any suitable electronic component that may provide a modifying or triggering input to the user device 104a. For example, the one or more device peripherals 191 may be speakers configured to release audio signals (e.g., voice signals or commands) during media playback operations. In another example, the one or more device peripherals 191 may be microphones configured to capture audio signals from the user 108a. In one or more embodiments, the one or more device peripherals 191 may be configured to operate continuously, at predetermined time periods or intervals, or on-demand.

The device processor 192 may comprise one or more processors communicatively coupled to and in signal communication with the device interfaces 190, the device peripherals 191, and the device memory 193. The device processor 192 is any electronic circuitry, including, but not limited to, state machines, one or more CPU chips, logic units, cores (e.g., a multi-core processor), FPGAs, ASICs, or DSPs. The device processor 192 may be a programmable logic device, a microcontroller, a microprocessor, or any suitable combination of the preceding. The one or more processors in the device processor 192 are configured to process data and may be implemented in hardware or software executed by hardware. For example, the device processor 192 may be an 8-bit, a 16-bit, a 32-bit, a 64-bit, or any other suitable architecture. The device processor 192 comprises an ALU to perform arithmetic and logic operations, processor registers that supply operands to the ALU, and store the results of ALU operations, and a control unit that fetches software instructions such as device instructions 194 from the device memory 193 and executes the device instructions 194 by directing the coordinated operations of the ALU, registers, and other components via a device processing engine (not shown). The device processor 192 may be configured to execute various instructions. For example, the device processor 192 may be configured to execute the device instructions 194 to implement functions or perform operations disclosed herein, such as some or all of those described with respect to FIGS. 1 and 2. In some embodiments, the functions described herein are implemented using logic units, FPGAs, ASICs, DSPs, or any other suitable hardware or electronic circuitry.

In one or more embodiments, the device profile 196 comprises information associated with a corresponding user device 104. In the example of FIG. 1, the device profile 196 comprises data associated with the user 108a. The local ML algorithms 198 may be configured to cleanse, normalize raw data, and derive intermediate data to generate uniform data in terms of encoding, format, and data types. The local ML algorithms 198 may be executed to run user queries and advanced analytical tools on the structured data and/or the unstructured data in accordance with one or more local ML models 103. The local ML models 103 may be configuration frameworks deployed and presented in real-time usage upon execution of the local ML algorithm 198.

### Network Devices

In one or more embodiments, the network devices 112 may be hardware and/or software executed by software configured to exchange information with one or more access points in the network 120. The network devices 112 may be configured to perform one or more of the data exchange operations 180 with one or more user devices 104 based on one or more entitlements 148 for the one or more services 144. Examples of network devices 112 comprise, but are not limited to, a laptop, a computer, a smartphone, a tablet, a smart device, an IoT device, a virtual reality device, an augmented reality device, or any other suitable type of device.

The network devices 112 may be hardware configured to create, transmit, and/or receive information. The network devices 112 may be configured to receive inputs from a user, process the inputs, and generate data information or command information in response. The data information may include documents or files generated using a graphical user interface (GUI). In one or more embodiments, while FIG. 1 shows the network device 112a, the network device 112b, and the network device 112c, a given environment 110 may comprise less or more the network devices 112.

### Process to Reduce Latency in Machine Learning Models

FIG. 2 illustrates an example flowchart of a process 200 configured to reduce latency in machine learning (ML) models. Modifications, additions, or omissions may be made to the process 200. The process 200 may comprise more, fewer, or other operations than those shown in FIG. 2. For example, operations may be performed in parallel or in any suitable order. While at times discussed as the server 102, the user devices 104, the network devices 112, or components of any of thereof performing operations described in operations 202-232 in the process 200, any suitable system or components of the system 100 may perform one or more operations of the process 200. For example, one or more operations of the process 200 may be implemented, at least in part, in the form of instructions 141 of FIG. 1, stored on non-transitory, tangible, machine-readable media (e.g., a non-transitory computer readable medium such as the server memory 140 of FIG. 1) that when run by one or more processors (e.g., the server processor 136 of FIG. 1) may cause the one or more processors to perform operations described in operations 202-232.

In one or more embodiments, the process 200 is configured to reduce latency in local ML models 103. In particular, the process 200 comprises executing the server ML algorithm 166 to correct performance delays and/or latency issues in the local ML models 103. The process 200 is configured to reduce, prevent, and/or eliminate performance delays and/or latency issues in the local ML models 103 after the local ML models 103 are updated from previous configurations to new configurations in one or more update procedures. The local ML models 103 may be configuration frameworks deployed and presented in real-time usage upon execution of a local ML algorithm 198 in user devices 104 and/or network devices 112 communicatively coupled to the server 102. The process 200 may determine latency causes 156 for local ML models 103 undergoing performance delays and/or latency issues. In this regard, the process 200 may determine one or more corrective operations 170 to reduce, prevent, and/or eliminate performance delays and/or latency issues to continue in the local ML models 103. The latency causes 156 may be results of recent updates to information parameters 182 in the local ML models 103. The information parameters 182 may comprise triggers 183, outputs 184, and data sets 185 used to train and/or maintain the local ML models 103. The corrective operations 170 may comprise selective changes to specific elements in the information parameters 182. For example, the systems may determine that execution of a local ML algorithm 198 in accordance with a specific local ML model 103 is causing latency issues because of changes to a local database and/or data set 185. In this example, the latency issues may be caused because the local ML model 103 is not updated to account for one or more changes (e.g., data sizes 160, data types, and the like) in the local database. Herein, the corrective operations 170 suggested and/or implemented by the process 200 may comprise additional updates to the local ML model 103 to account for the one or more changes to the local database.

In one or more embodiments, while the process 200 is described in reference to the local ML model 103a shared by the user device 104a and the network device 112a, the process 200 may be performed for one or more additional local ML models 103.

The process 200 starts at operation 202, where the server 102 is configured to receive information parameters 182 associated with a local ML model 103a. Herein, the information parameters 182 associated with the local ML model 103a may be a basis to perform one or more of the data exchange operations 180 between the user device 104a and the server 102, other user devices 104, and/or the network devices 112. At operation 204, the server 102 is configured to evaluate the information parameters 182 in accordance with one or more latency classification operations 152 after executing a server ML algorithm 166. In response to receiving the information parameters 182, the server 102 may execute the server ML algorithm 166 to evaluate the information parameters 182 in accordance with the one or more latency classification operations 152. As described above, the latency classification operations 152 are configured to determine whether the local ML model 103a comprises one or more latency complications (e.g., latency causes 156). At operation 206, the server 102 may be configured to generate analysis results 154 indicating whether the local ML model 103a comprises one or more latency complications. In response to evaluating the information parameters 182, the server 102 is configured to generate analysis results 154 indicating that the local ML model 103 comprises the latency complications. The server 102 may be configured to generate multiple analysis results 154 in conjunction with one another.

The process 200 continues at operation 210, where the server 102 is configured to determine any latency causes 156 in the local ML model 103a. At operation 220, the server 102 is configured to determine whether latency complications are found in the local ML model 103a. If the server 102 determines that latency complications are found in the local ML model 103a (e.g., YES), the process 200 proceeds to operation 222. If the server 102 determines latency complications are not found in the local ML model 103a (e.g., NO), the process 200 proceeds to operation 232.

At operation 222, the server 102 is configured to determine at least one latency cause 156 of the latency complications based on the analysis results 154. The server 102 may be configured to determine one or more latency causes 156 of the one or more latency complications based on the analysis results 154. At operation 224, the server 102 is configured to determine corrective operations 170 configured to correct the one or more latency causes 156. At operation 226, the server 102 is configured to update the local ML model 103a to comprise the corrective operations 170. The process 200 may end at operation 228, where the server 102 may be configured to generate a report 188 configured to release an updated version of the local ML model 103a to the user device 104a and the network device 112a.

Alternatively, the process 200 may end at operation 232, where the server 102 may be configured to generate a report 188 indicating that the local ML model 103a does not comprise any identifiable latency complications. Herein, the server 102 generates the report 188 indicating that an updated version of the local ML model 103a does not include any delays and/or latency issues.

### SCOPE OF THE DISCLOSURE

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. An apparatus, comprising:
a memory operable to store:
a machine learning algorithm configured to evaluate latency in one or more machine learning models; and
a processor communicatively coupled to the memory and configured to:
receive a first plurality of information parameters associated with a first machine learning model of the one or more machine learning models, wherein:
the first plurality of information parameters is a first basis to perform a first plurality of data exchange operations; and
the first plurality of information parameters comprises a first plurality of data sets, a first plurality of triggers, and a first plurality of outputs;
in response to receiving the first plurality of information parameters, execute the machine learning algorithm to:
evaluate the first plurality of information parameters in accordance with one or more latency classification operations, the one or more latency classification operations being configured to determine whether the first machine learning model comprises a first plurality of latency complications;
in response to evaluating the first plurality of information parameters, generate a first plurality of analysis results indicating that the first machine learning model comprises the first plurality of latency complications;
determine a first latency cause of the first plurality of latency complications based on the first plurality of analysis results; and
determine a first plurality of corrective operations configured to correct the first latency cause;
update the first machine learning model to comprise the first plurality of corrective operations; and
generate a first report configured to release an updated version of the first machine learning model.

2. The apparatus of claim 1, wherein the processor is further configured to:
receive a second plurality of information parameters associated with a second machine learning model out of the one or more machine learning models, wherein:
the second plurality of information parameters is a second basis to perform a second plurality of data exchange operations; and
the second plurality of information parameters comprises a second plurality of data sets, a second plurality of triggers, and a second plurality of outputs;
in response to receiving the second plurality of information parameters, execute the machine learning algorithm to:
evaluate the second plurality of information parameters in accordance with the one or more latency classification operations, the one or more latency classification operations being configured to determine whether the second machine learning model comprises a second plurality of latency complications;
in response to evaluating the second plurality of information parameters, generate a second plurality of analysis results indicating that the second machine learning model comprises the second plurality of latency complications;
determine a second latency cause of the second plurality of latency complications based on the second plurality of analysis results; and
determine a second plurality of corrective operations configured to correct the second latency cause;
update the second machine learning model to comprise the second plurality of corrective operations; and
generate a second report configured to release an additional updated version of the second machine learning model.

3. The apparatus of claim 2, wherein:
the second latency cause comprises unexpected data changes in a plurality of data sets; and
the second plurality of corrective operations comprise one or more prescription operations configured to train the second machine learning model to expect data changes in the plurality of data sets.

4. The apparatus of claim 2, wherein:
the second latency cause comprises an unexpected data size of a plurality of data sets; and
the second plurality of corrective operations comprise one or more clustering operations configured to train the second machine learning model to account for a new data size of the plurality of data sets.

5. The apparatus of claim 2, wherein:
the second latency cause comprises an unexpected data size of the second machine learning model; and
the second plurality of corrective operations comprise one or more logic operations configured to train the second machine learning model to account for a new data size of the second machine learning model.

6. The apparatus of claim 2, wherein:
the second latency cause comprises roundtrip time delays of the second plurality of triggers in a communication network communicatively coupled to the apparatus; and
the second plurality of corrective operations comprise one or more prediction operations configured to train the second machine learning model to account for the roundtrip time delays of the second plurality of triggers.

7. The apparatus of claim 1, wherein the processor is further configured to:
receive a second plurality of information parameters associated with a second machine learning model out of the one or more machine learning models, wherein:
the second plurality of information parameters is a second basis to perform a second plurality of data exchange operations; and
the second plurality of information parameters comprises a second plurality of data sets, a second plurality of triggers, and a second plurality of outputs;
in response to receiving the second plurality of information parameters, execute the machine learning algorithm to:
evaluate the second plurality of information parameters in accordance with the one or more latency classification operations, the one or more latency classification operations being configured to determine whether the second machine learning model comprises a second plurality of latency complications and a third plurality of latency complications;
in response to evaluating the second plurality of information parameters, generate a second plurality of analysis results indicating that the second machine learning model comprises the second plurality of latency complications;
determine a second latency cause of the second plurality of latency complications based on the second plurality of analysis results;
determine a second plurality of corrective operations configured to correct the second latency cause;
in conjunction with generating the second plurality of analysis results, generate a third plurality of analysis results indicating that the second machine learning model comprises the third plurality of latency complications;
determine a third latency cause of the third plurality of latency complications based on the second plurality of analysis results; and
determine a third plurality of corrective operations configured to correct the second latency cause;
update the second machine learning model to comprise the second plurality of corrective operations and the third plurality of corrective operations; and
generate a second report configured to release an additional updated version of the second machine learning model.

8. A method, comprising:
receiving a first plurality of information parameters associated with a first machine learning model of one or more machine learning models, wherein:
the first plurality of information parameters is a first basis to perform a first plurality of data exchange operations; and
the first plurality of information parameters comprises a first plurality of data sets, a first plurality of triggers, and a first plurality of outputs;
in response to receiving the first plurality of information parameters, executing a machine learning algorithm to perform one or more operations comprising:
evaluating the first plurality of information parameters in accordance with one or more latency classification operations, the one or more latency classification operations being configured to determine whether the first machine learning model comprises a first plurality of latency complications;
in response to evaluating the first plurality of information parameters, generating a first plurality of analysis results indicating that the first machine learning model comprises the first plurality of latency complications;
determining a first latency cause of the first plurality of latency complications based on the first plurality of analysis results; and
determining a first plurality of corrective operations configured to correct the first latency cause;
updating the first machine learning model to comprise the first plurality of corrective operations; and
generating a first report configured to release an updated version of the first machine learning model.

9. The method of claim 8, further comprising:
receiving a second plurality of information parameters associated with a second machine learning model out of the one or more machine learning models, wherein:
the second plurality of information parameters is a second basis to perform a second plurality of data exchange operations; and
the second plurality of information parameters comprises a second plurality of data sets, a second plurality of triggers, and a second plurality of outputs;
in response to receiving the second plurality of information parameters, executing the machine learning algorithm to perform one or more first additional operations comprising:
evaluating the second plurality of information parameters in accordance with the one or more latency classification operations, the one or more latency classification operations being configured to determine whether the second machine learning model comprises a second plurality of latency complications;
in response to evaluating the second plurality of information parameters, generating a second plurality of analysis results indicating that the second machine learning model comprises the second plurality of latency complications;
determining a second latency cause of the second plurality of latency complications based on the second plurality of analysis results; and
determining a second plurality of corrective operations configured to correct the second latency cause;
updating the second machine learning model to comprise the second plurality of corrective operations; and
generating a second report configured to release an additional updated version of the second machine learning model.

10. The method of claim 9, wherein:
the second latency cause comprises unexpected data changes over in a plurality of data sets; and
the second plurality of corrective operations comprise one or more prescription operations configured to train the second machine learning model to expect data changes in the plurality of data sets.

11. The method of claim 9, wherein:
the second latency cause comprises an unexpected data size of a plurality of data sets; and
the second plurality of corrective operations comprise one or more clustering operations configured to train the second machine learning model to account for a new data size of the plurality of data sets.

12. The method of claim 9, wherein:
the second latency cause comprises an unexpected data size of the second machine learning model; and
the second plurality of corrective operations comprise one or more logic operations configured to train the second machine learning model to account for a new data size of the second machine learning model.

13. The method of claim 9, wherein:
the second latency cause comprises roundtrip time delays of the second plurality of triggers in a communication network; and
the second plurality of corrective operations comprise one or more prediction operations configured to train the second machine learning model to account for the roundtrip time delays of the second plurality of triggers.

14. The method of claim 8, further comprising:
receiving a second plurality of information parameters associated with a second machine learning model out of the one or more machine learning models, wherein:
the second plurality of information parameters is a second basis to perform a second plurality of data exchange operations; and
the second plurality of information parameters comprises a second plurality of data sets, a second plurality of triggers, and a second plurality of outputs;
in response to receiving the second plurality of information parameters, execute the machine learning algorithm to perform one or more second additional operations comprising:
evaluating the second plurality of information parameters in accordance with the one or more latency classification operations, the one or more latency classification operations being configured to determine whether the second machine learning model comprises a second plurality of latency complications and a third plurality of latency complications;
in response to evaluating the second plurality of information parameters, generating a second plurality of analysis results indicating that the second machine learning model comprises the second plurality of latency complications;
determining a second latency cause of the second plurality of latency complications based on the second plurality of analysis results;
determining a second plurality of corrective operations configured to correct the second latency cause;
in conjunction with generating the second plurality of analysis results, generating a third plurality of analysis results indicating that the second machine learning model comprises the third plurality of latency complications;
determining a third latency cause of the third plurality of latency complications based on the second plurality of analysis results; and
determining a third plurality of corrective operations configured to correct the second latency cause;
updating the second machine learning model to comprise the second plurality of corrective operations and the third plurality of corrective operations; and
generating a second report configured to release an updated version of the second machine learning model.

15. A non-transitory computer-readable medium storing instructions that when executed by a processor cause the processor to:
receive a first plurality of information parameters associated with a first machine learning model of one or more machine learning models, wherein:
the first plurality of information parameters is a first basis to perform a first plurality of data exchange operations; and
the first plurality of information parameters comprises a first plurality of data sets, a first plurality of triggers, and a first plurality of outputs;
in response to receiving the first plurality of information parameters, execute a machine learning algorithm to:
evaluate the first plurality of information parameters in accordance with one or more latency classification operations, the one or more latency classification operations being configured to determine whether the first machine learning model comprises a first plurality of latency complications;
in response to evaluating the first plurality of information parameters, generate a first plurality of analysis results indicating that the first machine learning model comprises the first plurality of latency complications;
determine first latency cause of the first plurality of latency complications based on the first plurality of analysis results; and
determine a first plurality of corrective operations configured to correct the first latency cause;
update the first machine learning model to comprise the first plurality of corrective operations; and
generate a first report configured to release an updated version of the first machine learning model.

16. The non-transitory computer-readable medium of claim 15, wherein the instructions further cause the processor to:
receive a second plurality of information parameters associated with a second machine learning model out of the one or more machine learning models, wherein:
the second plurality of information parameters is a second basis to perform a second plurality of data exchange operations; and
the second plurality of information parameters comprises a second plurality of data sets, a second plurality of triggers, and a second plurality of outputs;
in response to receiving the second plurality of information parameters, execute the machine learning algorithm to:
evaluate the second plurality of information parameters in accordance with the one or more latency classification operations, the one or more latency classification operations being configured to determine whether the second machine learning model comprises a second plurality of latency complications;
in response to evaluating the second plurality of information parameters, generate a second plurality of analysis results indicating that the second machine learning model comprises the second plurality of latency complications;
determine a second latency cause of the second plurality of latency complications based on the second plurality of analysis results; and
determine a second plurality of corrective operations configured to correct the second latency cause;
update the second machine learning model to comprise the second plurality of corrective operations; and
generate a second report configured to release an additional updated version of the second machine learning model.

17. The non-transitory computer-readable medium of claim 16, wherein:
the second latency cause comprises unexpected data changes over in the second plurality of data sets; and
the second plurality of corrective operations comprise one or more prescription operations configured to train the second machine learning model to expect data changes in the second plurality of data sets.

18. The non-transitory computer-readable medium of claim 16, wherein:
the second latency cause comprises an unexpected data size of the second plurality of data sets; and
the second plurality of corrective operations comprise one or more clustering operations configured to train the second machine learning model to account for a new data size of the second plurality of data sets.

19. The non-transitory computer-readable medium of claim 16, wherein:
the second latency cause comprises an unexpected data size of the second machine learning model; and
the second plurality of corrective operations comprise one or more logic operations configured to train the second machine learning model to account for a new data size of the second machine learning model.

20. The non-transitory computer-readable medium of claim 16, wherein:
the second latency cause comprises roundtrip time delays of the second plurality of triggers in a communication network; and
the second plurality of corrective operations comprise one or more prediction operations configured to train the second machine learning model to account for the roundtrip time delays of the second plurality of triggers.
